(19) United States
(12) Patent Application Publication
(10) Pub. No.: US 2026/0194717 A1
(43) Pub. Date: Jul. 9, 2026

(54) DUAL HEATER COUPLED RING RESONATORS

(71) Applicant: Lightmatter, Inc., Boston, MA (US)

(72) Inventors: Adam Mendrela, Cambridge, MA (US); Alexander Sludds, Cambridge, MA (US)

(73) Assignee: Lightmatter, Inc., Boston, MA (US)

(21) Appl. No.: 19/442,544

(22) Filed: Jan. 7, 2026

Related U.S. Application Data
(60) Provisional application No. 63/742,954, filed on Jan. 8, 2025.

(51) Int. Cl. G02B 6/293

(52) U.S. Cl. CPC G02B 6/29338; G02B 6/29395

(57) ABSTRACT

An optical device includes a first optical resonator and a second optical resonator optically coupled to the first optical resonator. A first heater is thermally coupled to the first optical resonator and a second heater is thermally coupled to the second optical resonator. The second heater is configured to be controlled separately from the first heater. A photodetector is coupled to the optical device to monitor light output from the coupled resonators. A controller applies a common-mode dither to the first heater and the second heater. Prior to applying the common-mode dither, the controller reads a first output from the photodetector. Subsequent to applying the common-mode dither, the controller reads a second output from the photodetector. The controller adjusts voltages applied to the first heater and the second heater based on a comparison between the first output and the second output to compensate for variations between the resonators.

### CROSS-REFERENCE TO RELATED APPLICATION

This application claims the benefit of U.S. Provisional Application Ser. No. 63/742,954, filed on Jan. 8, 2025, under Attorney Docket No. L0858.70115US00 and entitled “DUAL HEATER COUPLED RING RESONATORS,” which is hereby incorporated herein by reference in its entirety.

### BACKGROUND

Optical communication systems employing wavelength-division multiplexing (WDM) technology transmit multiple wavelength channels simultaneously over a single optical fiber, with each channel carrying independent data streams. Optical filters are used throughout the communication link to separate and process individual wavelength channels. Optical resonators, such as ring resonators, may be used for wavelength-selective filtering due to their compact size and tunable resonance characteristics.

### SUMMARY

In some aspects, the techniques described herein relate to a method for controlling an optical device, including: applying a common-mode dither to: a first heater thermally coupled to a first optical resonator, and a second heater thermally coupled to a second optical resonator, wherein the first optical resonator is optically coupled to the second optical resonator; prior to applying the common-mode dither, reading a first output from a photodetector coupled to the optical device; subsequent to applying the common-mode dither, reading a second output from the photodetector; and adjusting a voltage applied to the first heater and a voltage applied to the second heater based on a comparison between the first output and the second output.

In some aspects, the techniques described herein relate to a method, wherein adjusting the voltage applied to the first heater and the voltage applied to the second heater based on the comparison between the first output and the second output includes determining whether a difference between the first output and the second output is positive or negative.

In some aspects, the techniques described herein relate to a method, wherein the common-mode dither increments voltages applied to the first heater and the second heater by a same amount.

In some aspects, the techniques described herein relate to a method, further including: subsequent to applying the common-mode dither, applying a differential-mode dither to the first heater and the second heater.

In some aspects, the techniques described herein relate to a method, wherein the differential-mode dither increments the voltage applied to the first heater while decrementing the voltage applied to the second heater by a same amount.

In some aspects, the techniques described herein relate to a method, further including: prior to applying the differential-mode dither, reading a third output from the photodetector; subsequent to applying the differential-mode dither, reading a fourth output from the photodetector; and adjusting the voltage applied to the first heater and the voltage applied to the second heater based on a comparison between the third output and the fourth output.

In some aspects, the techniques described herein relate to a method, wherein the method is repeated iteratively until a saddle point or a peak point is identified in the output of the photodetector.

In some aspects, the techniques described herein relate to a method, wherein the first and second optical resonators have matching roundtrip optical path lengths.

In some aspects, the techniques described herein relate to a method, wherein adjusting the voltage applied to the first heater and the voltage applied to the second heater based on the comparison between the third output and the fourth output includes determining whether a difference between the third output and the fourth output is positive or negative.

In some aspects, the techniques described herein relate to an optical device, including: a first optical resonator and a second optical resonator optically coupled to the first optical resonator; a first heater thermally coupled to the first optical resonator and a second heater thermally coupled to the second optical resonator; a photodetector; and a controller configured to: apply a common-mode dither to the first heater and the second heater; prior to applying the common-mode dither, read a first output from the photodetector; subsequent to applying the common-mode dither, read a second output from the photodetector; and adjust a voltage applied to the first heater and a voltage applied to the second heater based on a comparison between the first output and the second output.

In some aspects, the techniques described herein relate to an optical device, wherein adjusting the voltage applied to the first heater and the voltage applied to the second heater based on the comparison between the first output and the second output includes determining whether a difference between the first output and the second output is positive or negative.

In some aspects, the techniques described herein relate to an optical device, wherein the controller is further configured to: subsequent to applying the common-mode dither, apply a differential-mode dither to the first heater and the second heater.

In some aspects, the techniques described herein relate to an optical device, wherein the controller is configured to iteratively apply the common-mode dither and the differential-mode dither until a saddle point or peak point is identified in the output of the photodetector.

In some aspects, the techniques described herein relate to an optical device, wherein the first and second optical resonators have matching roundtrip optical path lengths.

In some aspects, the techniques described herein relate to an optical device, including: a first optical resonator; a second optical resonator optically coupled to the first optical resonator; a first heater thermally coupled to the first optical resonator; and a second heater thermally coupled to the second optical resonator, wherein the second heater is configured to be controlled separately from the first heater.

In some aspects, the techniques described herein relate to an optical device, further including a first digital-to-analog converter (DAC) for controlling the first heater and a second DAC for controlling the second heater.

In some aspects, the techniques described herein relate to an optical device, wherein the first heater and the second heater include resistive loops disposed inside the first optical resonator and the second optical resonator, respectively.

In some aspects, the techniques described herein relate to an optical device, further including a first waveguide evanescently coupled to the first optical resonator and a second waveguide evanescently coupled to the second optical resonator, wherein the first waveguide defines an input port and a through port, and the second waveguide defines a drop port.

In some aspects, the techniques described herein relate to an optical device, further including a photodetector coupled to the drop port.

In some aspects, the techniques described herein relate to an optical device, further including a controller configured to control voltages applied to the first heater and the second heater based on an output from the photodetector.

### BRIEF DESCRIPTION OF FIGURES

Various aspects and embodiments of the application will be described with reference to the following figures. It should be appreciated that the figures are not necessarily drawn to scale. Items appearing in multiple figures are indicated by the same reference number in the figures in which they appear.

FIG. 1A illustrates a dual-ring coupled ring resonator configuration, in accordance with some embodiments.

FIG. 1B is a plot illustrating the response of the dual-ring coupled ring resonator configuration of FIG. 1A as a function of temperature, in accordance with some embodiments.

FIG. 2 illustrates an optical device with individually controllable heaters, in accordance with some embodiments.

FIG. 3A illustrates how the response of an optical device may vary for different coupling coefficients, in accordance with some embodiments.

FIG. 3B illustrates a circuit diagram of coupled optical resonators emphasizing the coupling coefficient (k1) between a ring and a waveguide, in accordance with some embodiments.

FIG. 4A illustrates how the response of an optical device may vary for different coupling coefficients between rings, in accordance with some embodiments.

FIG. 4B illustrates a circuit diagram of coupled optical resonators emphasizing the coupling coefficient (k2) between rings, in accordance with some embodiments.

FIG. 5A-5B illustrate a contour plot of loss characteristics, in accordance with some embodiments.

FIG. 6 illustrates a three-dimensional contour plot of detector current, in accordance with some embodiments.

FIG. 7 illustrates a block diagram of an optical device with a control system, in accordance with some embodiments.

FIG. 8 illustrates a flowchart of a locking process, in accordance with some embodiments.

FIG. 9 illustrates a timing diagram of a locking process, in accordance with some embodiments.

FIG. 10 illustrates a simplified electronic schematic of an optical device, in accordance with some embodiments.

FIG. 11 illustrates progression of a locking point through a locking process, in accordance with some embodiments.

FIG. 12 illustrates a block diagram of an optical device, in accordance with some embodiments.

### DETAILED DESCRIPTION

Optical communication systems employing wavelength-division multiplexing (WDM) technology have been widely adopted to meet the ever-increasing demand for high-speed data transmission. In some cases, these systems utilize coupled ring resonators (CRRs) as bandpass or notch filters to separate and process individual wavelength channels. A CRR is an optical structure, typically evanescently coupled to a bus waveguide, that extracts light if the wavelength matching condition is satisfied. Thus, CRRs are wavelength selective. As such, CRRs can be used to perform optical filtering, multiplexing, and demultiplexing. A CRR may be implemented as two or more rings optically in series with one another and having matching resonances. However, the performance of CRRs may be susceptible to manufacturing variations and environmental factors, which can lead to misalignment between the resonance wavelengths of the coupled rings. This misalignment may result in degraded filter performance, increased passband loss, reduced stopband rejection, and increased crosstalk between adjacent WDM channels.

Dual-ring CRRs may use two rings coupled in series between two parallel bus waveguides to create a bandpass filter between the two waveguides. In some embodiments, a CRR is designed to have matching optical resonators (e.g., rings). Optical resonators of the types described herein are said to be matched if the optical path lengths corresponding to one roundtrip are the same or substantially the same. In some embodiments, the optical path lengths are said to be substantially the same if the difference in absolute terms is less than 20 nm, less than 10 nm or less than 5 nm. Alternatively, the optical path lengths are said to be substantially the same if the difference is within 0.05% of the nominal path length, within 0.024% of the nominal path length, or within 0.012% of the nominal path length. In one example, both resonators are designed to have a nominal path length of 42 μm; the resonators are said to be matched even if the path length of one resonator deviates from the nominal value by 20 nm. In the matched configuration, the optical resonators have the same free spectral range (FSR). As a result, the FSR of the CRR is equal to the FSR of each resonator.

Any mismatch between the two rings may create a resonance misalignment and degrade the filter performance. As a result, the passband response may stretch out and incur more passband loss, while the stopband may become shallower, increasing crosstalk between two WDM channels. This extra loss and crosstalk may lower the performance of an optical WDM receiver that uses two rings.

While some of the difference in ring dimensions may be due to limited etching precision in the fabrication process, another cause of radii mismatch between the rings in a CRR may be the difference in heater resistance between the two rings, which creates a temperature gradient between the rings. Conventionally, any loss due to ring mismatch is built into the link budget of the device in which the CRR is used. Whereas conventional CRRs stabilize the rings together using a single voltage digital-to-analog converter (DAC) driving a single heater across the rings (or, in some cases, a heater for each ring but all the heaters are shorted so that they are controlled by the same DAC), the inventors have recognized that ring mismatch due to differences between physical and thermal properties of the rings can be compensated for, at least in part, with individual ring control. Accordingly, the present disclosure describes optical devices with individualized thermal control of optical resonators and methods for individually controlling the temperature of the resonators.

In some embodiments, a CRR is intentionally designed to have mismatching optical resonators (e.g., rings). For example, the optical path length of one optical resonator may be two to five times larger than the optical path length of the other resonator. When a CRR has mismatched resonators, each resonator has a different FSR. The combined response of the CRR exhibits a Vernier effect, where the overall FSR of the optical device becomes the least common multiple of the individual FSRs. Therefore, the effective FSR of the mismatched CRR is larger than either individual resonator's FSR. The resonances of the two rings only align periodically at wavelengths where both resonators are simultaneously resonant. Some embodiments exploit this effect to extend the effective FSR beyond what a single resonator of practical size could achieve. The extended FSR allows banks of optical devices to process a greater number of WDM channels.

The techniques described herein can be applied to optical devices with nominally matched resonators (examples of which are illustrated below) as well as to optical devices with intentionally mismatched resonators.

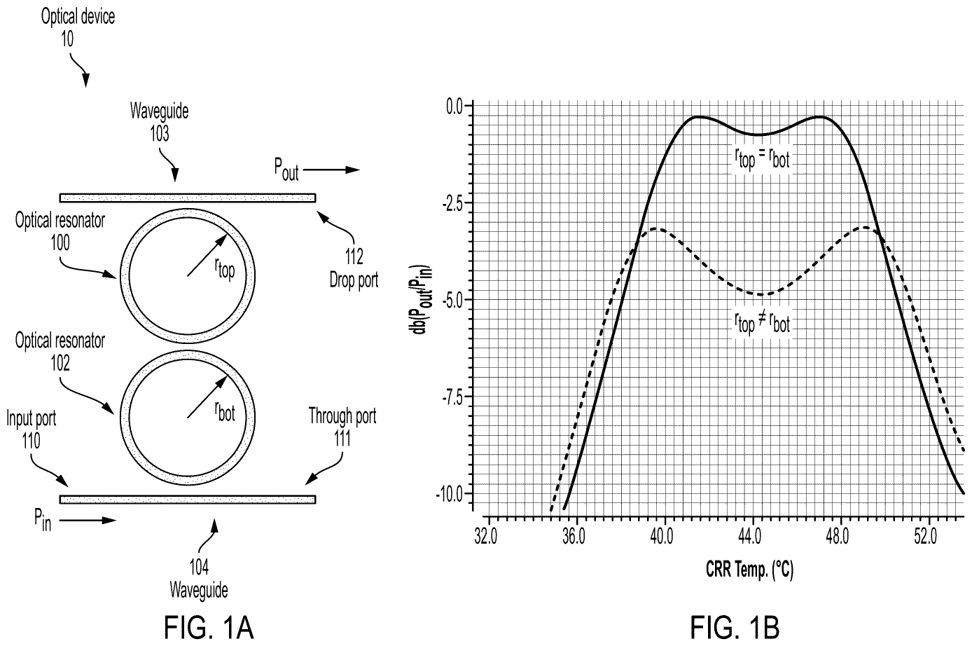

Referring to FIG. 1A, an optical device 10 may include an optical resonator 100 and an optical resonator 102, optically in series with optical resonator 100. The first optical resonator 100 may be optically coupled to the second optical resonator 102, via evanescent coupling. Optical resonators 100 and 102 are designed to have matching roundtrip optical path lengths, at least nominally. In practice, they may be slightly mismatched, due to fabrication tolerances and/or environmental effects. A waveguide 103 may be positioned adjacent to the first optical resonator 100 and may be evanescently coupled thereto. A waveguide 104 may be positioned adjacent to the second optical resonator 102 and may be evanescently coupled thereto. In some embodiments, the waveguide 104 defines an input port 110 where input power Pᵢₙ enters the device, and a through port 111. The waveguide 103 may define a drop port 112 where output power Pₒᵤₜ exits the device. The optical resonators may be ring-shaped, ellipsoidal, racetrack-shaped, disk-shaped, or any other closed shape. In some cases, the first optical resonator 100 may have a radius rₜₒₚ, and the second optical resonator 102 may have a radius r_{bot}. The radius of a ring resonator serves as a proxy for the optical length of the resonator. Optical resonators other than rings, such as disk resonators or racetrack resonators, may not be characterized by a single radius but nonetheless have an optical length that may be subject to variations as described herein.

Light may be input through the waveguide 104 at the input port 110. Light of a wavelength that does not couple to the optical resonators may continue propagating to the through port 111 and may then be incident on one or more additional optical devices that may be tuned to couple light of a different wavelength. Light that couples to the second optical resonator 102 may transfer to the first optical resonator 100 and exit through the drop port 112 of the waveguide 103. In some embodiments, light coupled to the drop port 112 is incident on a photodetector to convert the optical signal into an electrical signal that may be further processed.

It should be noted that optical device 10 may be used in unidirectional architectures as well as in bidirectional architectures. In unidirectional architectures, light is provided only from one side of waveguide 104, as shown in FIG. 1A. In bidirectional architectures, by contrast, light is provided from both sides of waveguide 104. As a result, optical device 10 defines two distinct drop ports on opposite sides of waveguide 103; one drop port for each input. Optical device 10 is configured to perform optical filtering in both directions simultaneously.

Referring to FIG. 1B, a plot illustrates the response of the dual-ring coupled ring resonator configuration of FIG. 1A as a function of temperature. The plot includes two responses: one in which the radii of the rings are matched (rₜₒₚ equals r_{bot}) and one in which the radii are slightly mismatched (rₜₒₚ different from r_{bot}). When the radii are matched, the response may exhibit a sharper, more defined passband with lower loss and steeper roll-off characteristics. When the radii are not matched, the response may be broader and distorted, with degraded passband characteristics, increased loss, and reduced selectivity compared to the matched case.

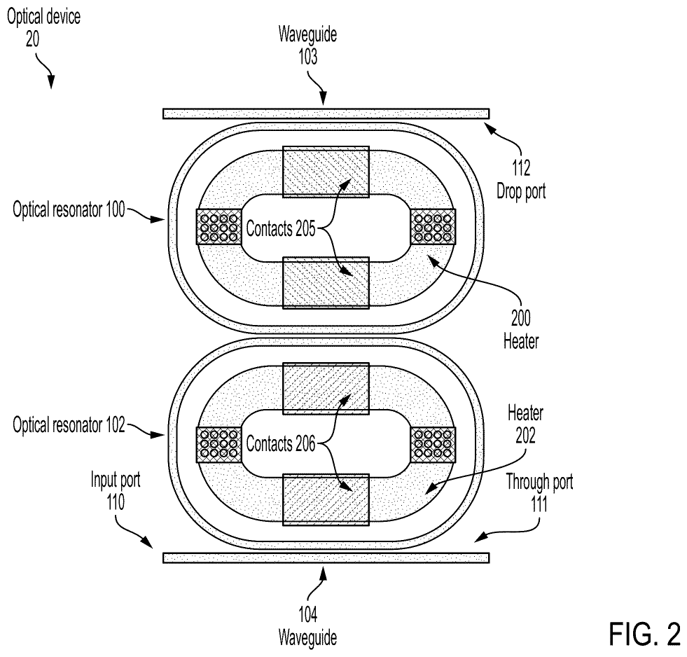

Referring now to FIG. 2, an optical device 20 may include a first heater 200 thermally coupled to the first optical resonator 100 and a second heater 202 thermally coupled to the second optical resonator 102. Optical resonators 100 and 102 are matched (at least nominally). In some embodiments, the second heater 202 is configured to be controlled separately from the first heater 200. The first heater 200 and the second heater 202 may comprise resistive loops disposed inside the first optical resonator 100 and the second optical resonator 102, respectively. The first heater 200 may include first contacts 205 positioned on opposite sides of the first optical resonator 100, and the second heater 202 may include second contacts 206 positioned on opposite sides of the second optical resonator 102. The first contacts 205 and the second contacts 206 may provide electrical connections for independently controlling the temperature of each optical resonator.

In some embodiments, the optical device 20 includes a first digital-to-analog converter (DAC) for controlling the first heater 200 and a second DAC for controlling the second heater 202. By separately controlling the two heaters, a controller may apply a temperature gradient across the two optical resonators which can be used to tune each resonator independently. In some embodiments, a tuning process can be used to search various heater combinations to find an optimal or near optimal combination to compensate for the process mismatch effects.

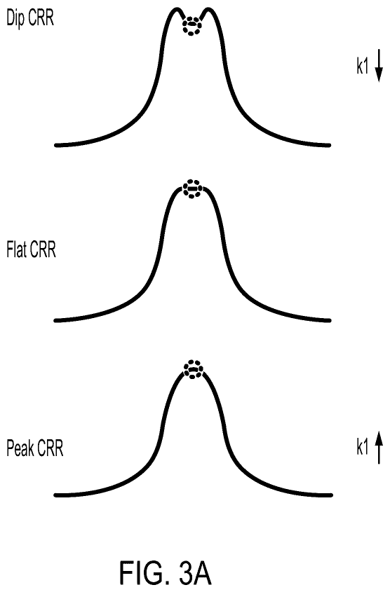

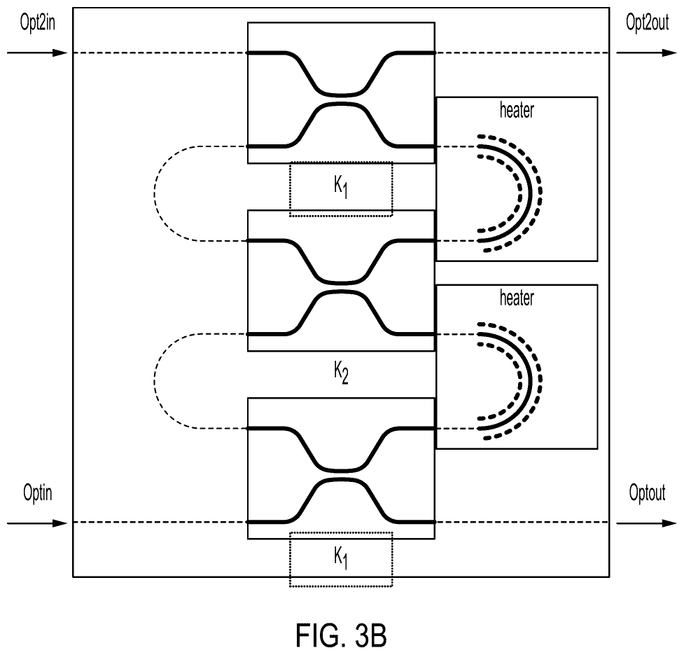

A CRR may have a variety of responses to input light as a function of the wavelength of the incoming light, temperature of the rings, the coupling coefficients between the bus waveguide and the ring (referred to here as k1), and the coupling coefficient between the two rings (referred to here as k2). In one example, k1 is about 0.574 and k2 is about 0.212. Referring to FIG. 3A, three types of possible responses are illustrated as the average temperature of the CRR is swept from low to high temperature for three different values of k1. As the coupling between the ring and the waveguide (k1) decreases, the response of the CRR may go from having a dip in the middle (top graph), to having a flat response (middle graph), to having a peak in the middle (bottom graph). The top graph shows a dip CRR response where the optimal lock point calls for dip locking. The bottom graph shows a peak CRR response where the optimal lock point calls for peak locking.

Referring to FIG. 3B, a circuit diagram illustrates an optical device comprising coupled optical resonators with individually controllable heaters. The diagram shows directional coupler sub-components with coupling coefficients k1 (between the bus waveguides and the resonators) and k2 (between the two resonators). Two heater elements are positioned on the right side of the circuit, each associated with a respective optical resonator section.

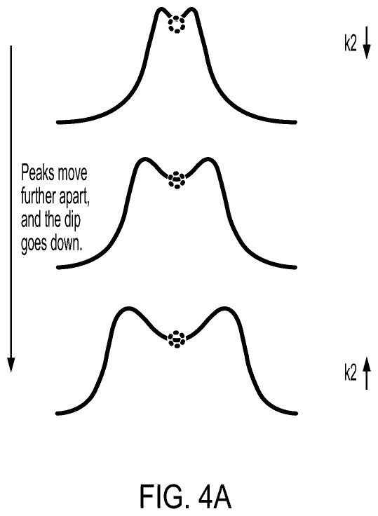

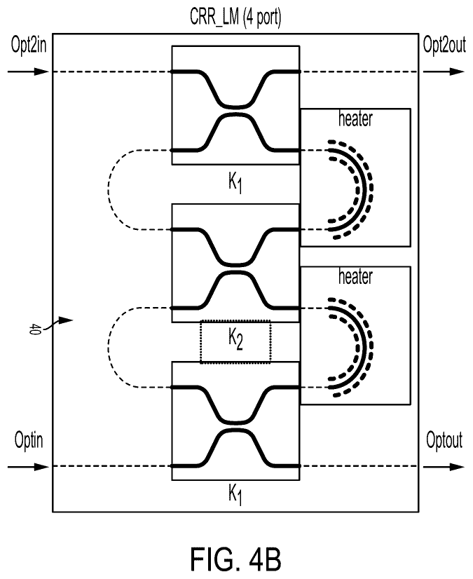

Referring to FIG. 4A, the response of the CRR may change as a function of the coupling coefficient k2 between the two rings. As the coupling between the two rings (k2) decreases, the depth of the dip may increase and the two peaks may separate further apart. FIG. 4B illustrates a schematic diagram of a coupled ring resonator device with a four-port configuration, showing the structural arrangement with coupling coefficients k1 and k2 and individually controllable heater elements.

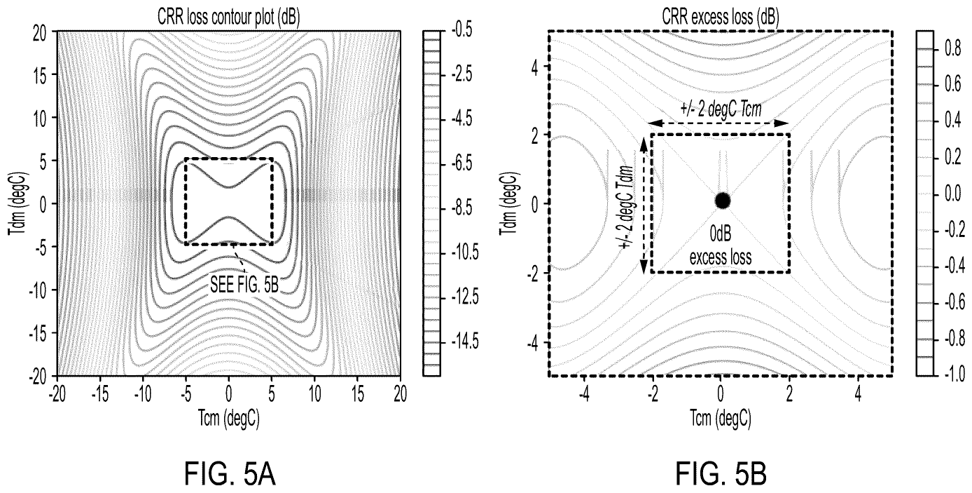

Referring to FIGS. 5A-5B, a contour plot illustrates the loss characteristics of a coupled ring resonator as a function of temperature parameters. The horizontal axis represents T_{cm}, which is the average temperature of the two rings, such that T_{cm}=(T_{ring,top}+T_{ring,bot})/2, where T_{ring,top} is the temperature of the first optical resonator and T_{ring,bot} is the temperature of the second optical resonator. The vertical axis represents T_{dm}, which is the temperature difference between the two rings, such that T_{dm}=T_{ring,top}−T_{ring,bot}. In some embodiments, T_{cm} is used to tune the center wavelength of the passband while T_{dm} is used to specifically offset the mismatch present in the rings.

With continued reference to FIG. 5A, the contour plot displays a saddle-shaped pattern. The optimal lock point of the CRR is shown as a black dot in the center of the saddle-shaped contour plot. This lock point represents the point where the signal has little attenuation and even sideband bandwidth. FIG. 5B shows a zoomed-in view with a red square representing a ±2 degrees Celsius tolerance window. If the temperature of the rings stays within this box, the CRR may remain stable and maintain minimal excess loss.

In some embodiments, to find the lock point, the state of the CRR heaters is first moved by varying the T_{cm} and the T_{dm} to be in the vicinity of the lock point. Then, the optimal lock point can be tracked by minimizing the T_{cm} dimension and maximizing the T_{dm} dimension. If ring mismatch is present, the contour plot may shift up or down. By maximizing T_{dm}, the algorithm can track the optimal lock point even if optimal T_{dm} does not equal zero. In some cases where process variations result in a saddle that is almost non-existent, the process can be altered to track the peaks instead, by maximizing both the T_{cm} and T_{dm} dimensions.

Since heater resistors are used in some embodiments to control the temperature in each ring, the voltage applied to the heaters can be controlled in a similar common-mode (CM) and differential-mode (DM) fashion to tune the CRR for optimal center wavelength and calibrated mismatch. Similarly to T_{cm} and T_{dm}, the voltages V_{cm}=(Vₕₑₐₜₑᵣ₁+Vₕₑₐₜₑᵣ₂)/2 and V_{dm}=(Vₕₑₐₜₑᵣ₁−Vₕₑₐₜₑᵣ₂) can be defined, where Vₕₑₐₜₑᵣ₁ is the voltage applied to the first heater, Vₕₑₐₜₑᵣ₂ is the voltage applied to the second heater, V_{cm} is the common-mode voltage representing the average of the two heater voltages, and V_{dm} is the differential-mode voltage representing the difference between the two heater voltages.

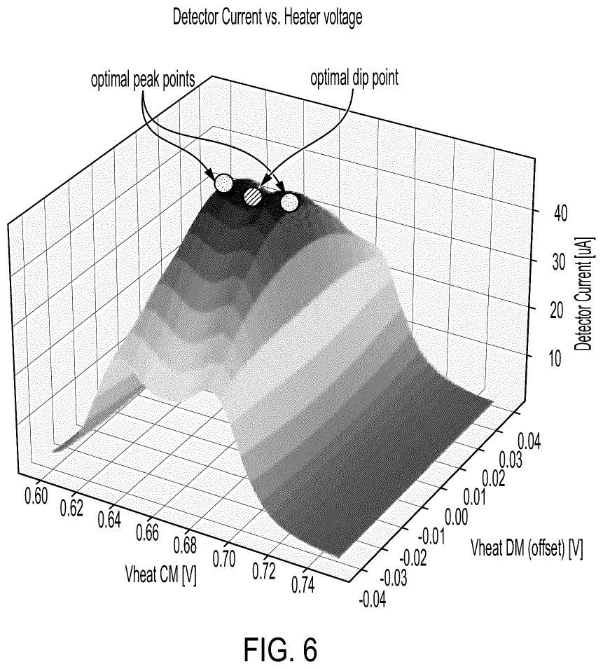

Referring to FIG. 6, a three-dimensional contour plot illustrates the detector current as a function of heater voltage parameters (the placement of the detector will be described in detail further below). The vertical axis represents detector current measured in microamperes. One horizontal axis represents the common-mode heater voltage V_{cm}, and the other horizontal axis represents the differential-mode heater voltage offset V_{dm}. The surface exhibits a saddle-shaped topology with a central dip region flanked by two peak regions. The optimal dip point is indicated by a central dot located at the saddle point of the surface, representing the lock point where the common-mode voltage is tuned to minimize detector current. Two optimal peak points are indicated by a pair of dots positioned on either side of the optimal dip point along the differential-mode axis.

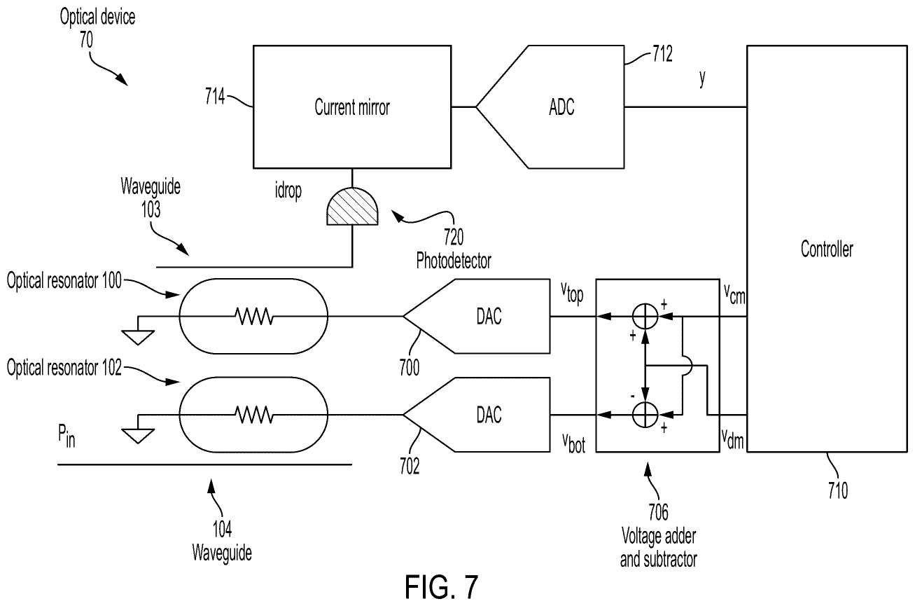

Referring to FIG. 7, a block diagram illustrates an optical device 70 with a control system for managing coupled optical resonators. Optical resonators 100 and 102 are matched (at least nominally). The optical device 70 includes the first optical resonator 100 and the second optical resonator 102, which are optically coupled to each other. The first optical resonator 100 is coupled to the waveguide 103, and the second optical resonator 102 is coupled to the waveguide 104. An input power Pᵢₙ is provided to the waveguide 104. The waveguide 103 includes the drop port 112 from which light exits the coupled resonator structure.

The optical device 70 may include a photodetector 720 positioned at the drop port 112 to detect light output from the coupled optical resonators. The photodetector 720 may generate a current signal i_{drop} corresponding to the detected optical power. This current signal may be provided to a current mirror 714, which creates a copy of the photodetector current for use by the control system. The output from the current mirror 714 may be fed to an ADC 712, which converts the analog current signal to a digital output signal y. This digital signal y may be provided to a controller 710, which processes the signal and generates control voltages v_{cm} and v_{dm}. The controller 710 may implement a locking process to maintain the optical resonators at an optimal operating point.

As further shown in FIG. 7, the control voltages v_{cm} and v_{dm} from the controller 710 may be provided to a voltage adder and subtractor 706. The voltage adder and subtractor 706 may convert the common-mode voltage v_{cm} and differential-mode voltage v_{dm} into individual heater voltages vₜₒₚ and v_{bot}. The voltage vₜₒₚ may be provided to a first DAC 700, which controls the first heater 200 thermally coupled to the first optical resonator 100. The voltage v_{bot} may be provided to a second DAC 702, which controls the second heater 202 thermally coupled to the second optical resonator 102. This configuration allows for independent thermal control of each optical resonator to compensate for manufacturing variations and environmental factors that may cause resonance misalignment between the coupled resonators.

In some embodiments, the controller 710 is configured to control voltages applied to the first heater 200 and the second heater 202 based on an output from the photodetector 720. The controller 710 may apply a common-mode dither to the first heater 200 and the second heater 202. Prior to applying the common-mode dither, the controller 710 may read a first output from the photodetector 720. Subsequent to applying the common-mode dither, the controller 710 may read a second output from the photodetector 720. The controller 710 may then adjust a voltage applied to the first heater 200 and a voltage applied to the second heater 202 based on a comparison between the first output and the second output. Further, the controller 710 may apply a differential-mode dither to the first heater 200 and the second heater 202. Prior to applying the differential-mode dither, the controller 710 may read a third output from the photodetector 720. Subsequent to applying the differential-mode dither, the controller 710 may read a fourth output from the photodetector 720. The controller 710 may then adjust the voltage applied to the first heater 200 and the voltage applied to the second heater 202 based on a comparison between the third output and the fourth output.

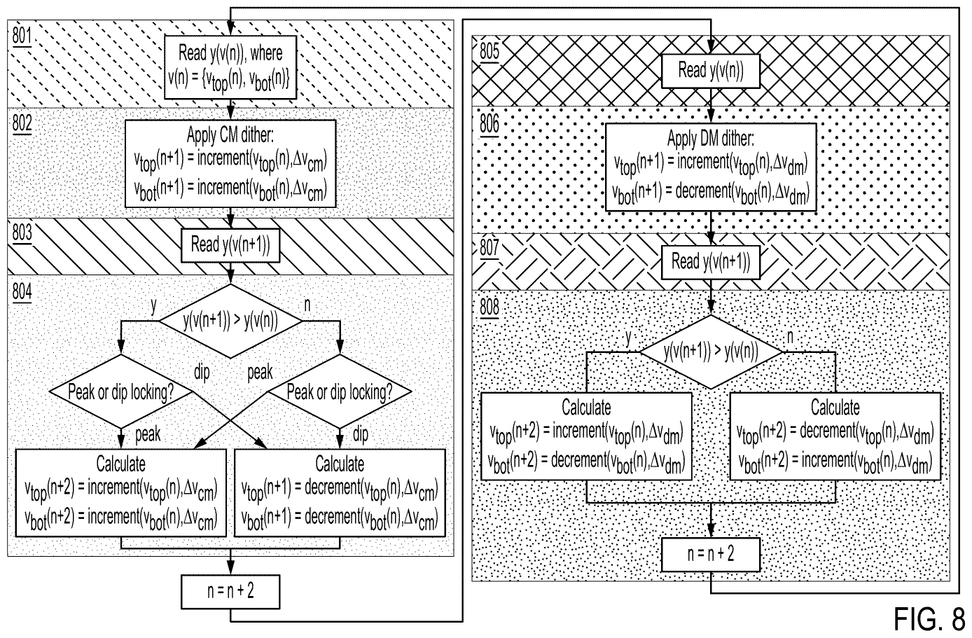

Referring now to FIG. 8, a flowchart illustrates a locking process for controlling a coupled ring resonator device. The process of FIG. 8 is described as being configured to compensate for mismatches between optical resonators that are nominally designed to be matched, where the mismatches arise from fabrication tolerances or environmental effects. However, not all embodiments are limited in this respect. Some embodiments, for example, may use the process of FIG. 8 in the context of intentionally mismatched resonators. In such embodiments, the locking process of FIG. 8 may be used to maintain the resonators at a desired operating point where the resonances of the two resonators align at a target wavelength. While the extended FSR provides greater separation between adjacent resonant peaks, the common-mode and differential-mode dithering approach described herein may be used to ensure that the resonances remain aligned at the target wavelength despite fabrication and environmental variations. In other words, the approach described herein maintains the desired Vernier alignment.

Referring back to FIG. 8, the process may include steps that alternate between common-mode (CM) and differential-mode (DM) dithering and updating operations. In the drawings, n represents a discrete time index of the algorithm. vₜₒₚ(n) represents the voltage across the top heater resistor while v_{bot}(n) represents the voltage across the bottom heater resistor. Δv_{cm} represents the increment value of the heater voltages in CM fashion, while Δv_{dm} represents the increment value of the heater voltages in DM fashion. y(v(n)) represents the measured photodetector output current as a function of the two heater voltage settings. Controller 710 may perform the locking process of FIG. 8.

The process may begin with step 801, where the controller reads the photodetector output y(v(n)), where v(n) represents the voltage settings for both the top and bottom heaters. The process may then proceed to step 802, where a CM dither is applied by incrementing both the top heater voltage and the bottom heater voltage. In some embodiments, the common-mode dither increments the voltages applied to the first heater and the second heater by a same amount. Following this, step 803 may involve reading the photodetector output after the CM dither has been applied.

At step 804, the process may compare the photodetector readings before and after the CM dither. In some embodiments, adjusting the voltage applied to the first heater and the voltage applied to the second heater based on the comparison between the first output and the second output comprises determining whether a difference between the first output and the second output is positive or negative. If the second reading is greater than the first reading, the process may check whether peak or dip locking is being performed. For peak locking with a positive difference, or dip locking with a negative difference, the heater voltages may be incremented. For the opposite conditions, the heater voltages may be decremented. The process may then update the time index by incrementing n by 2.

The process may continue to step 805, where the photodetector output is read again. Step 806 may apply a DM dither by incrementing the top heater voltage while decrementing the bottom heater voltage. In some embodiments, the differential-mode dither increments the voltage applied to the first heater while decrementing the voltage applied to the second heater by a same amount. Step 807 may involve reading the photodetector output after the DM dither has been applied.

At step 808, the process may compare the photodetector readings before and after the DM dither. In some embodiments, adjusting the voltage applied to the first heater and the voltage applied to the second heater based on the comparison between the third output and the fourth output comprises determining whether a difference between the third output and the fourth output is positive or negative. If the reading after the DM dither is greater than the reading before, the top heater voltage may be incremented and the bottom heater voltage may be decremented. If the reading after is less than the reading before, the top heater voltage may be decremented and the bottom heater voltage may be incremented. The time index may then be updated by incrementing n by 2, and the process may return to step 801 to repeat the cycle.

In some embodiments, the method is repeated iteratively until a saddle point is identified in the output of the photodetector. In other embodiments, the method is repeated iteratively until a peak point is identified in the output of the photodetector. The separated CM and DM dithering followed by updates allows the locking process to perform a stable and efficient search for the optimal locking point in the two-dimensional CM/DM space.

In some embodiments, different directions of the dither may be used, with each option having different advantages and disadvantages. The dither may always be applied in the same direction, for example, always first incrementing by a positive voltage step, or always incrementing by a negative voltage step. Alternatively, the dither may be applied in alternating directions, where every time the algorithm steps through the eight steps, the increment voltage is switched from positive to negative or from negative to positive. This dither scheme may make the algorithm more robust to input optical power fluctuations. In some cases, the dither may be applied in a random fashion, where a random number generator toggled every full eight-step cycle selects the polarity of the increment voltage. In yet other embodiments, the dither polarity may be set according to the update from the last cycle, such that if the previous cycle had a positive update in step 804, the dither in step 802 of the next cycle will also be positive, and vice-versa.

In addition to adjusting the direction of the voltage applied to the first and second heaters, in some embodiments, a controller may further adjust the magnitude of the voltage applied to the heaters. The magnitude may be adjusted based on the magnitude and direction of the difference between the photodetector readings before and after the dither (whether common-mode dither or differential-mode dither), rather than by a fixed increment. For example, if the difference between the first output and the second output is large, the controller may apply a larger voltage adjustment, whereas if the difference is small, the controller may apply a smaller voltage adjustment. This approach may allow the algorithm to converge more quickly when the operating point is far from the optimal lock point and to make finer adjustments when the operating point is close to the optimal lock point.

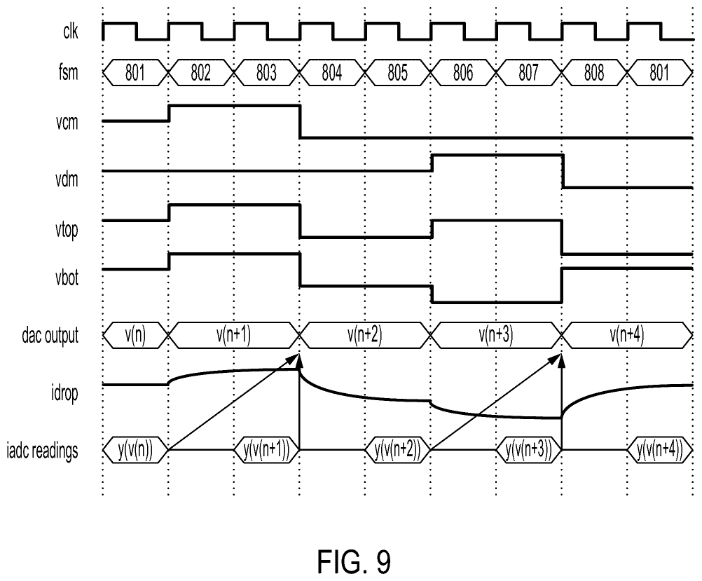

Referring to FIG. 9, a timing diagram illustrates the temporal relationship between various signals during the process of FIG. 8. The signals shown include a clock signal (clk), finite state machine states (fsm) progressing through steps 801 through 808, a common-mode voltage signal (V_{cm}), a differential-mode voltage signal (v_{dm}), a top heater voltage signal (vₜₒₚ), a bottom heater voltage signal (v_{bot}), a DAC output signal showing voltage values v(n) through v(n+4), a current signal (i_{drop}), and ADC readings showing corresponding measurements y(v(n)) through y(v(n+4)).

With continued reference to FIG. 9, the process may begin with step 801, where an initial photodetector reading y(v(n)) is captured. During step 802, a common-mode dither may be applied, causing both V_{cm} and the heater voltages vₜₒₚ and v_{bot} to transition. Step 803 may capture a subsequent photodetector reading y(v(n+1)) after the ring temperature settles. Step 804 may perform a comparison between consecutive readings to determine whether to maintain or reverse the voltage update. Step 805 through 808 may perform analogous operations for differential-mode dithering, where the v_{dm} signal transitions and causes vₜₒₚ and v_{bot} to move in opposite directions.

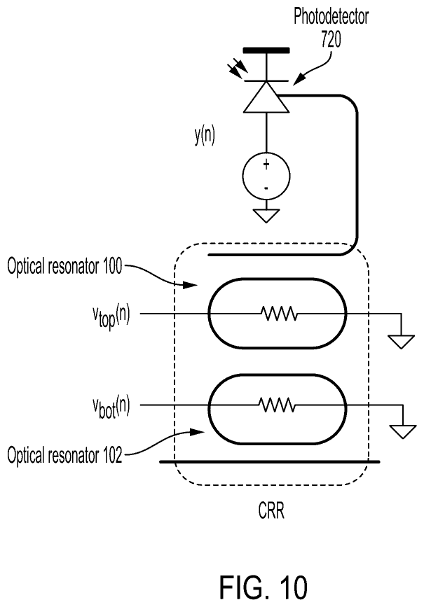

Referring to FIG. 10, a simplified electronic schematic illustrates a coupled ring resonator configuration used to describe the locking process. The diagram shows the CRR enclosed within a dashed boundary and includes the optical resonator 100 and the optical resonator 102 arranged vertically within the CRR structure. Each optical resonator is depicted with an associated resistive heater element shown as a zigzag symbol. The optical resonator 100 receives a voltage designated as vₜₒₚ(n), while the optical resonator 102 receives a voltage designated as v_{bot}(n). A waveguide path connects the CRR to the photodetector 720. The voltage source labeled y(n) represents the measured photodetector output current as a function of the two heater voltage settings.

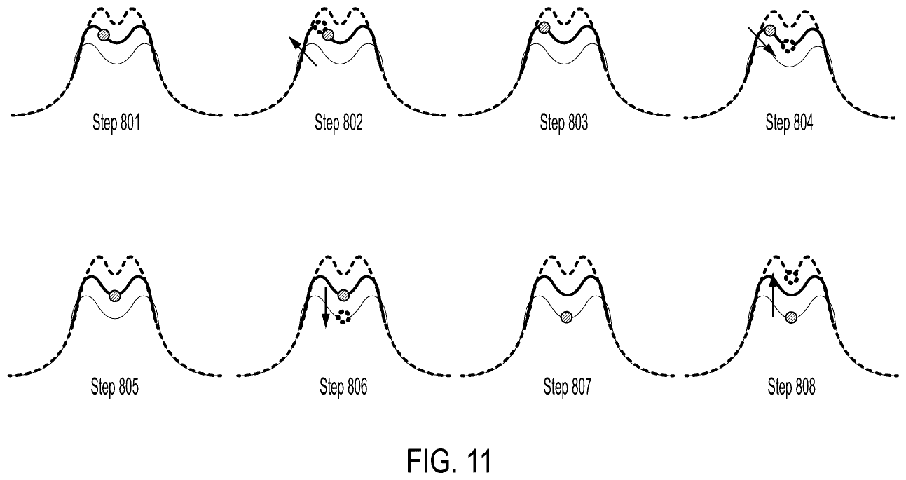

Referring to FIG. 11, a series of eight diagrams illustrates the progression of a locking point through each step of the locking process, in accordance with one example. Each diagram shows a response surface with a characteristic dual-peak structure and central dip. A filled circle indicates the current locking point position. In steps 801 through 804, the locking point may move along one dimension of the response surface, corresponding to the common-mode dithering and update phase of the algorithm. In steps 805 through 808, the locking point movement may correspond to the differential-mode dithering and update phase. The progression through all eight steps demonstrates how the algorithm may systematically perturb the heater settings in both common-mode and differential-mode fashion to locate and maintain the optimal saddle point position.

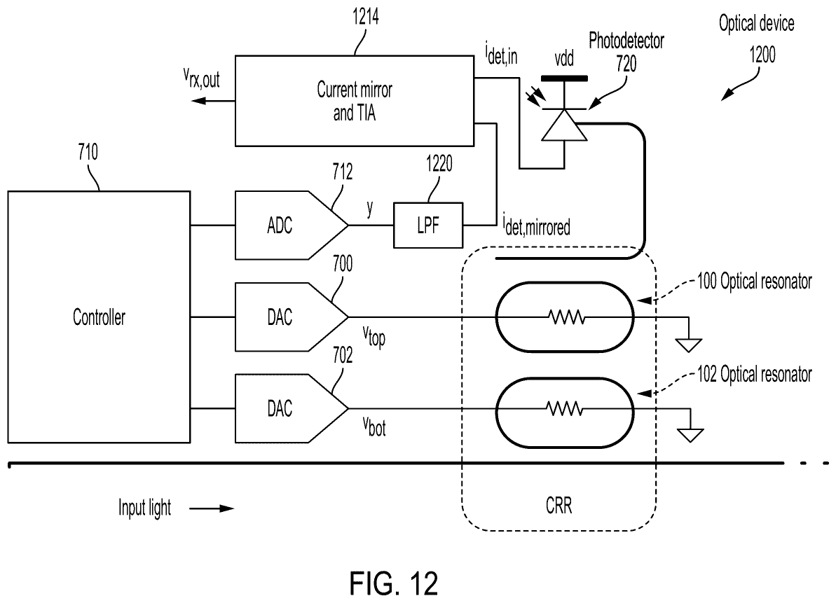

Referring to FIG. 12, a block diagram illustrates another optical device (1200) according to some embodiments. The optical device 1200 includes a coupled ring resonator comprising the optical resonator 100 and the optical resonator 102, which are optically coupled to each other and are matched (at least nominally). Input light enters the system through a waveguide at the bottom of the diagram and interacts with the CRR. The optical resonator 100 is thermally coupled to a heater controlled by the DAC 700, which provides a voltage vₜₒₚ to the heater associated with the optical resonator 100. Similarly, the optical resonator 102 is thermally coupled to a heater controlled by the DAC 702, which provides a voltage v_{bot} to the heater associated with the optical resonator 102.

With continued reference to FIG. 12, a photodetector 720 may be coupled to the drop port of the CRR to convert optical signals into electrical current i_{det,in}. The photodetector 720 may be connected to a current mirror and TIA 1214, which may serve two functions. The current mirror and TIA 1214 may convert the photodetector current to an output receiver voltage v_{rx,out} for downstream processing. The current mirror and TIA 1214 may also create a mirrored copy of the photodetector current, labeled i_{det,mirrored}, which may be used for the locking algorithm.

As further shown in FIG. 12, the mirrored current i_{det,mirrored} may be provided to a low-pass filter (LPF) 1220, which performs low-pass filtering on the signal. The filtered signal may then be converted to a digital code y by the ADC 712. The controller 710 may receive the digital code y from the ADC 712 and implement a locking process to control the voltages applied to the heaters. The controller 710 may output control signals to the DAC 700 and the DAC 702 to adjust vₜₒₚ and v_{bot}, respectively, thereby maintaining the CRR at an optimal operating point. This feedback loop may enable the system to compensate for process variations and dynamic temperature changes affecting the optical resonators.

Optical device 1200 may be used in unidirectional architectures (as shown in FIG. 12) as well as in bidirectional architectures. In bidirectional architectures, the output waveguide defines two distinct drop ports on opposite sides thereof. These architectures may include two photodetectors; one for each of the output waveguide's drop ports. Each photodetector may independently monitor the state of the resonators as described above.

While examples described herein describe the FSM in a particular order, the ordering of states in the FSM may be slightly reshuffled and still perform separate CM and DM dithering. For example, interleaving the DM and CM dimension dither and update steps may be possible if appropriate ADC values are tracked separately for each dimension. Also, instead of controlling CM and DM dimensions, the controller in some embodiments may dither and update individual DACs sequentially.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. A method for controlling an optical device, comprising:
applying a common-mode dither to:
a first heater thermally coupled to a first optical resonator, and
a second heater thermally coupled to a second optical resonator, wherein the first optical resonator is optically coupled to the second optical resonator;
prior to applying the common-mode dither, reading a first output from a photodetector coupled to the optical device;
subsequent to applying the common-mode dither, reading a second output from the photodetector; and
adjusting a voltage applied to the first heater and a voltage applied to the second heater based on a comparison between the first output and the second output.

2. The method of claim 1, wherein adjusting the voltage applied to the first heater and the voltage applied to the second heater based on the comparison between the first output and the second output comprises determining whether a difference between the first output and the second output is positive or negative.

3. The method of claim 1, wherein the common-mode dither increments voltages applied to the first heater and the second heater by a same amount.

4. The method of claim 1, further comprising:
subsequent to applying the common-mode dither, applying a differential-mode dither to the first heater and the second heater.

5. The method of claim 4, wherein the differential-mode dither increments the voltage applied to the first heater while decrementing the voltage applied to the second heater by a same amount.

6. The method of claim 4, further comprising:
prior to applying the differential-mode dither, reading a third output from the photodetector;
subsequent to applying the differential-mode dither, reading a fourth output from the photodetector; and
adjusting the voltage applied to the first heater and the voltage applied to the second heater based on a comparison between the third output and the fourth output.

7. The method of claim 6, wherein the method is repeated iteratively until a saddle point or a peak point is identified in the output of the photodetector.

8. The method of claim 1, wherein the first and second optical resonators have matching roundtrip optical path lengths.

9. The method of claim 6, wherein adjusting the voltage applied to the first heater and the voltage applied to the second heater based on the comparison between the third output and the fourth output comprises determining whether a difference between the third output and the fourth output is positive or negative.

10. An optical device, comprising:
a first optical resonator and a second optical resonator optically coupled to the first optical resonator;
a first heater thermally coupled to the first optical resonator and a second heater thermally coupled to the second optical resonator;
a photodetector; and
a controller configured to:
apply a common-mode dither to the first heater and the second heater;
prior to applying the common-mode dither, read a first output from the photodetector;
subsequent to applying the common-mode dither, read a second output from the photodetector; and
adjust a voltage applied to the first heater and a voltage applied to the second heater based on a comparison between the first output and the second output.

11. The optical device of claim 10, wherein adjusting the voltage applied to the first heater and the voltage applied to the second heater based on the comparison between the first output and the second output comprises determining whether a difference between the first output and the second output is positive or negative.

12. The optical device of claim 10, wherein the controller is further configured to: subsequent to applying the common-mode dither, apply a differential-mode dither to the first heater and the second heater.

13. The optical device of claim 12, wherein the controller is configured to iteratively apply the common-mode dither and the differential-mode dither until a saddle point or a peak point is identified in the output of the photodetector.

14. The optical device of claim 10, wherein the first and second optical resonators have matching roundtrip optical path lengths.

15. An optical device, comprising:
a first optical resonator;
a second optical resonator optically coupled to the first optical resonator;
a first heater thermally coupled to the first optical resonator; and
a second heater thermally coupled to the second optical resonator, wherein the second heater is configured to be controlled separately from the first heater.

16. The optical device of claim 15, further comprising a first digital-to-analog converter (DAC) for controlling the first heater and a second DAC for controlling the second heater.

17. The optical device of claim 15, wherein the first heater and the second heater comprise resistive loops disposed inside the first optical resonator and the second optical resonator, respectively.

18. The optical device of claim 15, further comprising a first waveguide evanescently coupled to the first optical resonator and a second waveguide evanescently coupled to the second optical resonator, wherein the first waveguide defines an input port and a through port, and the second waveguide defines a drop port.

19. The optical device of claim 18, further comprising a photodetector coupled to the drop port.

20. The optical device of claim 19, further comprising a controller configured to control voltages applied to the first heater and the second heater based on an output from the photodetector.
